(19) United States
(12) Patent Application Publication
(10) Pub. No.: US 2009/0210895 A1
(43) Pub. Date: Aug. 20, 2009

(54) SYSTEM AND METHOD FOR EDITING AN ADVERTISEMENT IN DIGITAL BROADCASTING

(75) Inventor: Jin Yong Joo, Gyunggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: INTERNET CHANNEL21 CO., LTD., Seoul (KR)

(21) Appl. No.: 12/301,198

(22) PCT Filed: May 25, 2007
(86) PCT No.: PCT/KR07/02541

§ 371 Date: Nov. 17, 2008

(30) Foreign Application Priority Data
May 26, 2007 (KR) 10-2006-0047654

(51) Int. Cl. H04N 7/10

(52) U.S. Cl. 725/32

(57) ABSTRACT

Disclosed herein is an advertisement editing system and method for digital broadcasting. The advertisement editing system includes a control unit, an advertisement storage unit, and an editor. When broadcast packets are decoded in digital broadcasting equipment that receives and outputs broadcast signals, the control unit detects a broadcast and an advertisement contained in the broadcast packets, and searches for a new advertisement that is to replace the advertisement. The advertisement storage unit stores one or more new advertisements. The editor edits decoded broadcast signals and the new advertisement found by the advertisement storage unit, and synthesizes the decoded broadcast signals with the new advertisement so that they can be output via the digital broadcasting equipment. The advertisement editing system is configured such that it can output content, including the new advertisement, while operating in conjunction with the digital broadcasting equipment.

### TECHNICAL FIELD

The present invention relates to an advertisement editing system and method for digital broadcasting, which separate a typical broadcast and an advertisement contained in a digital broadcast, replace the advertisement through editing, and enable edited content to be output via the terminal that outputs the digital broadcast.

### BACKGROUND ART

Recently, with the advent of the digital era, various digital technologies have been actively introduced into the broadcasting field. In particular, the development of audio/video compression technology capable of processing data in a digital fashion is the fundamental basis of the implementation of digital satellite broadcasting.

Furthermore, digital satellite broadcasting is indebted to the development of a communications satellite and broadcasting technology, and is a result of phenomena in which barriers between the existing communications industry and computer industry and between the existing broadcasting industry and movie industry are being destroyed and elements that are traditionally considered the features of respective fields are infiltrating into the other fields.

As the standardization of a Moving Picture Experts Group-2 (MPEG-2) system (ISO/IEC 13818-1), video (ISO/IEC 13818-2) and audio (ISO/IEC 13818-3) has been completed by the MPEG committee (ISO/IEC JTC/SC2/WG11) of the International Standards Organization (ISO), and as the standardization of a digital television system (satellite, terrestrial, and cable systems), including service information, a scrambling method, and channel coding and modulation methods, has been successfully completed by the European Digital Video Broadcasting (BVB) Project and the Europe Telecommunications Standards Institute (ETSI), Digital Direct Broadcasting Satellite (DBS) broadcasting system technology, which is the basis of a digital satellite broadcasting system, is trending toward the international spread of implementation and sharing of technology.

The histories of principal digital satellite broadcasting-related services currently being provided are described in brief below. As American Prime Star Partners applied Digicipher technology, similar to MPEG, to conventional DBS and started Prime Star DBS service in the middle of 1994 and, at the same time, DirecTV/United States Satellite Broadcasting (USSB) Company started digital DBS service using MPEG-1 video technology, digital satellite broadcasting service became a reality.

Thereafter, in the beginning of 1996, Tee-Comm Corporation's AlphaStar service and EchoStar Communications Corporation's DISH Network, based on the MPEG-2 technology and the DVB standard, started service, and, thereafter, Japan and Europe actively participated in digital satellite broadcasting service using a communications satellite and a unique digital satellite broadcasting method. Furthermore, KT Corporation in Korea started digital satellite broadcasting service based on the MPEG-2 technology and the DVB standard via a Mugunghwa satellite on June, 1996.

The development of digital satellite broadcasting technology provides advantages in terms of television broadcasting, such as the efficient use of bandwidth of a relay, the improvement of quality of video and audio and the reduction in size of a receiving antenna, enables data service, and helps spread technology because the convergence between other communication systems, computer systems and heterogeneous digital broadcasting systems can be readily achieved based on the fact that transmission signals are digital. That is, digital satellite broadcasting employs compressed digital video and voice, so that the digital satellite broadcasting can assign a plurality of channels to a single relay, unlike existing analog satellite broadcasting, which can assign only a single channel to a single satellite broadcasting relay, thus more efficiently utilizing a given bandwidth compared to the analog satellite broadcasting, and the digital satellite communication can share information with communications systems and large-sized computer systems, so that the advent of various new information services is promoted.

As described above, digital satellite broadcasting has an environment in which various additional services as well as compressed digital video and voice can be offered, and has the advantages of service flexibility and channel extensibility attributable to digital signal processing compared to analog systems, thus having potential for the creation of new added value.

Furthermore, one of the chief features of digital satellite broadcasting is to support interactive communication between a broadcasting station and recipients, rather than to supply broadcasts in a one-way manner, unlike that of typical analog broadcasting. This implies that recipients can edit digital broadcasts from a broadcasting station and select and receive currently sent broadcasts at necessary times.

Meanwhile, with the advent of the Internet, the business environment escapes from the analog broadcasting pattern, in which only a small number of companies monopolizes business based on advertising profits due to regulation of frequencies, the authorization of governments, and the like, and is changing in that an unlimited number of broadcast channels can be provided, and broadcasting, communications and the Internet are converging due to a Broadband convergence Network project.

Furthermore, the conversion into digital broadcasting enables interactive communication, and terminals have developed from simple reception and display devices, are provided with high storage capacity, and enable the installation of user-controllable application programs.

Meanwhile, with the convergence of broadcasting, communications and the Internet, in addition to the unlimited setup of channels based on the development of the Internet, and the availability of storage and editing of content at receiving terminals, it is impossible for terrestrial broadcasting stations to monopolize the acceptance of orders for advertisements, and advertisers have come to be skeptical about the efficiency of advertising media, which are being diversified.

For these reasons, in the advertising market, online advertisements have overwhelmed advertisements in radio and magazines among advertisements in TV, radio, newspaper and magazines, which are called the “big four” advertising media, and have rapidly emerged on the market. However, chaos and reorganization in the advertising market are inevitable due to the future convergence of broadcasting, communications and the Internet.

Users must endure the unreasonableness of paying high communication expenses while receiving low-quality and similar content services that are provided by a plurality of providers to compensate for the loss of profits because Internet broadcasting communication is abundant, and thus profits are considerably reduced due to the distribution of orders for advertisements.

### DISCLOSURE OF INVENTION

### Technical Problem

Accordingly, the present invention is intended to escape from a method in which few providers transmit advertisements in a unilateral manner using their monopoly position, as in analog broadcasting, and is intended to reorganize the market such that the market can satisfy both service providers and users in such a way that consumers monopolize advertisements using high storage capacity and interactive communications technology, which are possessed by terminal devices in digital broadcasting, and by installing application programs that each display only a specific advertisement, provided by a specific service provider, on a specific terminal.

Accordingly, an object of the present invention is to provide an advertisement editing system for digital broadcasting which allows desired advertisements to be displayed at desired locations and at desired times by editing digital broadcasts, and which can more effectively perform advertising by providing users, who view broadcasts, with custom-made advertisements that consider the personal and local features of the users, rather than providing the same advertisements to all users.

### Advantageous Effects

According to the present invention, advertisements contained in digital broadcasts can be replaced with new advertisements through editing at terminals, that is, at receiving ends, and edited content can be output, so that monopolies on the acceptance of orders for advertisements based on the monopolies of broadcasting and communications providers, who monopolize the production of content and transmission equipment, can be prevented, and advertisements suitable for the personal and local characteristics of respective users can be selectively presented, with the result that an advantage arises in that the inefficiency of advertising, in which advertisements are uniformly broadcast without regard to users, can be overcome from the standpoint of advertisers.

Furthermore, according to the present invention, in market situations in which advertising media are diversified as the convergence of the Internet, capable of being used to set up unlimited channels, broadcasting and communications continues, so that efficiency is reduced in the advertising market, and in which high-speed communication network providers experience massive loss even though users pay high usage fees, advertisements can be monopolized and controlled by users, that is, the end consumers of advertisements, thereby solving the problems. In such business situations, the providers of terminals and networks used by users may take a method of making profits by monopolizing and controlling advertisements, and providing content or sharing advertising profits with content providers. Additionally, providers having financial power can employ a business strategy of monopolizing advertisements rather than providing terminals for free or at a low price.

### BRIEF DESCRIPTION OF THE DRAWINGS

FIG. 1 is a block diagram showing the construction of an advertisement editing system according to the present invention;

FIG. 2 is a diagram showing a broadcast and an advertisement that are output to a digital TV through the advertisement editing system according to the present invention; and

FIG. 3 is a flowchart sequentially showing an advertisement editing method according to the present invention.

### MODE FOR THE INVENTION

An advertisement editing system according to the present invention can be applied to digital radio broadcasting, DVD/DVR and IPTV, which is a broadcasting-led Internet integration service model, as well as digital satellite broadcasting. The present embodiment is described below, taking digital satellite broadcasting, which can be generally worked, as an example. However, it is clearly noted that DVD/DVR and IPTV content, including digital satellite broadcast content, is played through a process identical to that for broadcasts, so that the advertisement editing system according to the present invention can be worked and used in the form of a variety of variations without departing from the scope of the following claims. Accordingly, the technical spirit of the present invention can be applied to mobile devices, such as mobile phones, on which Digital multimedia Broadcasting (DMB) can be implemented.

The present invention is described in detail based on the accompanying drawings.

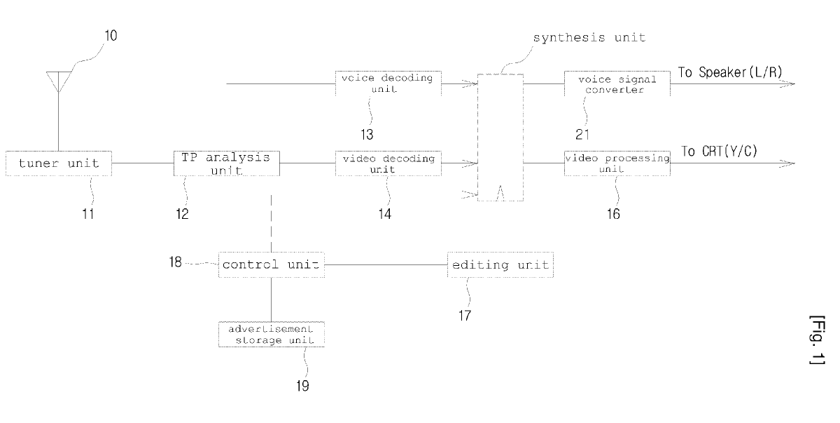

FIG. 1 is a block diagram showing the construction of an advertisement editing system according to the present invention. A description is given below with reference to this drawing.

A digital TV is a machine that receives digital broadcast signals sent from a broadcasting station, and provides video and audio to a viewer. Most current digital broadcasting follows the MPEG standards. In particular, MPEG-2, which is the MPEG standard for broadcasting, covers system, audio and video standards. For reference, the system standard number of the MPEG-2 is ISO/IEC 13818-1, the video standard number thereof is ISO/IEC 13818-2, and the audio standard number thereof is ISO/IEC 13818-3.

The structure of a digital TV set, which follows the standards of MPEG-2, and the operation principle of the advertisement editing system according to the present invention, which operates in conjunction with the digital TV set, are described below.

A typical digital TV set includes a tuner unit 11 for receiving digital broadcast signals, a TP analysis unit 12 for detecting audio/video signals by analyzing the TP signal of the digital broadcast signals received by the tuner unit 11, audio/video decoding units 13 and 14 for separating and decoding the audio/video signals detected by the TP analysis unit 12, an audio signal converter 21 for converting the digital audio signal, decoded by the audio decoding unit, into analog signals, an advertisement storage unit 19 for storing various types of advertisements, a control unit 18 for examining video from the video decoding unit 14, and searching the advertisement storage unit 19 for an alternative advertisement if an advertisement is included in a broadcast, and an editor 17 for perform editing so that the advertisement included in the broadcast is replaced with the new advertisement through editing.

The tuner unit 11 receives Quadrature Phase Shift Keying (QPSK) signals or Quadrature Amplitude Modulation (QAM) signals from an antenna 10 as inputs, detects the signals, corrects errors, and then outputs a transport signal string. The transport signal string has been standardized in the MPEG-2 system.

The transport signal string standardized according to the MPEG-2 standard is a time-multiplexed signal string, which is called a transport stream packet. In this transport signal string, a header is located in the initial part of a packet, and a Packet Identifier (PID) number is recorded in the header. A PID number can be used as information that is used to demultiplex time-multiplexed signals. Furthermore, a PID number indicates the type of a current packet. Whether a current packet is a video packet, an audio packet, or program-specific information is detected by analyzing a PID number.

The video standard and audio standard of MPEG-2 are regulations related to the signal streams of compressed video and voice. According to the MPEG-2 standard, video signals, voice signals and program-specific information signals are all time-multiplexed and sent in the form of a plurality of transport stream packets, and these signal streams are all distinguished using PID numbers.

Meanwhile, the tuner unit 11 is a component element required for a digital TV. When the present invention is applied to a DVD/DVR and an IPTV the tuner unit 11 is replaced.

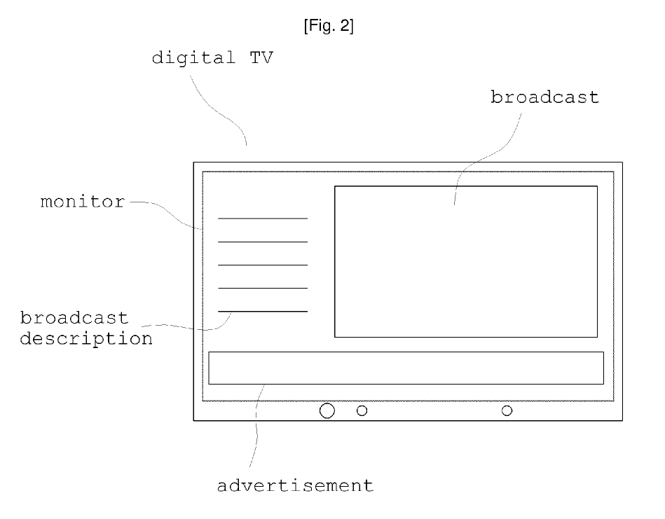

The TP analysis unit 12 analyzes this transport stream packet-type signal stream using a PID number, and applies it to one of the decoding units 13 and 14. That is, the TP analysis unit 12 receives the transport signal string received by the tuner unit, and detects a PTD NUMBER contained in the header of the signal stream. By doing so, the TP analysis unit distinguishes a video signal stream, a voice signal stream and a program-specific information signal stream according to the PID number. Then, the TP analysis unit applies a video signal stream to the video decoding unit 14, a voice signal stream to the audio decoding unit 13, and a program-specific information signal stream to the digital TV microcomputer (not shown). The program-specific information signal stream is a feature of a digital broadcast, includes descriptions about the various contents of a broadcast, and fills “broadcast description,” as shown in FIG. 2.

The video decoding unit 14 decodes the video signal stream applied from the TP analysis unit 12, and outputs the decoded video signal stream to the video processing unit 16. The video signal stream applied from the TP analysis unit is data that is compressed according to the MPEG-2 standard. Accordingly, the video decoding unit restores the compressed video signal stream to the original digital video data by decompressing the compressed video signal stream.

The audio decoding unit 13 decodes the voice signal stream applied from the TP analysis unit 12, and outputs the decoded voice signal stream to the digital to analog converter 21. The voice signal stream applied from the TP analysis unit is data that is compressed according to the MPEG-1 standard.

Accordingly, the audio decoding unit 13 restores the compressed voice signal stream to the original digital video data by decompressing the compressed voice signal stream.

The voice signal converter 21 converts the digital video data, applied from the audio decoding unit 13, into an analog voice signal that can be processed by an amplifier or a speaker. The analog voice signal is output in the form of a voice or sound by a stereo speaker (not shown).

The video processing unit 16 converts digital video data, applied from the video decoding unit 14, into luminance signals Y and chrominance signals C that can be implemented in a typical TV or a monitor. These luminance signals and chrominance signals are implemented as video by a CPT.

The advertisement storage unit 19 replaces an advertisement contained in a broadcast or provides an advertisement to be disposed in a vacant space, such as a menu screen, appearing when a user manipulates a digital TV, a menu bar or a tool bar while storing one of various types of advertisements in the form of data. Of course, advertisements stored in the advertisement storage unit 19 may be updated through regular or irregular upgrading. However, the present invention is not limited to this, but may receive an advertisement, together with a broadcast, from a broadcasting station (or a separate server) in real time and output it together with a broadcast.

Here, the term ‘advertisement’ refers to information that can be used to introduce a product or service to customers and arouse customers' interest in the product or service. However, the ‘advertisement’ according to the present invention is not limited to information having such a use, but may be typical information or content having various uses. Accordingly, the term ‘advertisement’ used in the present description is a word selected only for ease of description, so that the technical spirit according to the present invention is not worked in the state in which it is limited to a simple advertisement purpose. Accordingly, the advertisement may be information that contains public information, a campaign, a search for a missing child, news and some other various types of information.

Meanwhile, an advertisement contained in a typical broadcast is a moving image having a running time of 20 seconds, so that an advertisement stored in the advertisement storage unit 19 must be an advertisement of a type that can replace such an existing moving image advertisement. Other flash or simple image-type advertisements may be disposed in a vacant space, a menu bar or a tool bar within the menu screen of a digital TV as described above, therefore these can be a type of advertisement that may be edited in digital broadcasting.

Here, although the description has been given taking a digital TV as an embodiment of the present invention, the present invention may be applied to digital radio broadcasting. That is, this can be achieved by replacing the voice signals of an advertisement, which belong to the voice signals of a broadcast, rather than visual moving images, with the voice signals of a new advertisement. In the case of digital radio, the advertisement storage unit 19 stores MIDI files.

The control unit 18 controls the editor 17, reads the video decoding unit 14, detects information about an advertisement contained in the broadcast, and searches the advertisement storage unit 19 for a corresponding appropriate alternative advertisement.

The advertisement editing system for digital broadcasting according to the present invention replaces an advertisement of a broadcast, sent by a broadcasting station first, with some other advertisement through editing, and a viewer can finally receive the advertisement inserted by an advertisement editing system, instead of the advertisement sent from the broadcasting station. The advertisement control unit 18 and the advertisement storage unit 19 are added to a digital TV.

Before the digital TV adjusts broadcast signals sent from the voice decoding unit 13 and the video decoding unit 14, synthesizes them using a synthesis unit and outputs them via the speaker and the monitor, the editor 17 replaces the existing advertisement with a new advertisement, sent from the control unit 18, allows synthesis to be performed in the synthesis unit, and causes a finally edited broadcast to be output via the speaker and the monitor. Editing periods, editing locations, and content to be edited are determined under the control of the control unit 18.

Meanwhile, since a new advertisement can be disposed in a vacant space, a menu bar, or a tool bar within the menu screen of a digital TV, the editor 17 may perform setting so that a corresponding advertisement is eliminated when a cursor approaches a menu bar or a tool bar so as to prevent a user from being inconvenienced when using the menu bar or tool bar. Of course, when an advertisement needs to be eliminated as a mouse cursor approaches the advertisement, the advertisement may be completely eliminated. Alternatively, the portion of the advertisement that does not hinder the mouse cursor may be allowed to remain, and only the portion of the advertisement over which the mouse cursor is directly located may be eliminated.

FIG. 2 is a diagram showing a broadcast and an advertisement that are output to a digital TV through the advertisement editing system according to the present invention. The following description is given with reference to FIG. 2.

The advertisement editing system according to the present invention may output a broadcast with the existing advertisement of a broadcast replaced with a new advertisement, or may provide an advertisement together with an existing broadcast, as shown in FIG. 2. That is, the range of occupation of a broadcast over the entire monitor is reduced by reducing the size of the broadcast, and the broadcast is output with a new advertisement inserted into a vacant space that is formed through the reduction.

Of course, the location is not limited to the location illustrated, but the editor 17 sets a location designated by the control unit 18 or an arbitrary location, and inserts an advertisement at the set location.

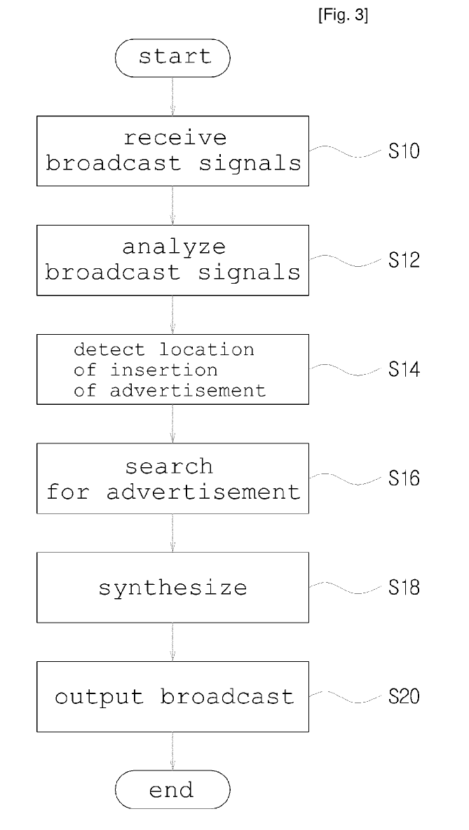

FIG. 3 is a flowchart sequentially showing an advertisement editing method according to the present invention.

S10; Step of Receiving Broadcast Signals

Broadcast signals sent from a broadcasting station are received through the tuner unit 11. Of course, although a component element related to the tuner unit 11 is presented because the above-described embodiment relates to a digital TV, the present invention does not limit the reception route for broadcast signals to such a tuner unit 11.

In general, when broadcast signals of interest are broadcast signals containing video, video signals, voice signals and program-specific information signals may be contained in the broadcast signals.

S12; Step of Analyzing Broadcast Signals

As described above, when the broadcast signals contain video, the broadcast signals may contain video signals, voice signals and program-specific information signals. Of course, when the broadcast signals are signals for radio broadcasting, the video signals may be omitted.

The TP analysis unit 12 detects video signals, voice signals and program-specific information signals by analyzing received broadcast signals.

The control unit 18 examines the analysis results of the TP analysis unit 12, and performs the following processing.

S14; Step of Detecting Location at Which Advertisement is to be Inserted

The control unit 18 detects a location at which a new advertisement is to be inserted through the analysis of broadcast signals. Here, the location at which the advertisement is to be inserted may include the location at which an existing advertisement is disposed, vacant space which is formed during the output of broadcast signals, and the location at which a menu bar is output when, in the case of a digital TV, a user outputs a window, such as the menu bar, onto a monitor using a remote control so as to manipulate a digital TV.

Meanwhile, in the case of the vacant space, it may be intentionally formed to insert a new advertisement. In greater detail, when a broadcasting station sends broadcast signals, the broadcasting station sends the broadcast signals with a vacant space artificially included therein so that the advertisement editing system according to the present invention can insert an advertisement, and the advertisement editing system receives these broadcast signals, inserts the advertisement into the corresponding vacant space, and outputs the broadcast, together with the advertisement.

S16; Step of Searching for Advertisement to be Inserted

The control unit 18 searches the advertisement storage unit 19 for an advertisement suitable for the location that was detected at the step of detecting the location at which the advertisement is to be inserted. In this case, the advertisement may always remain the same, or may be changed each time.

With regard to the present embodiment of the present invention, the step S16 of detecting the location at which the advertisement is to be inserted is not limited to searching for an advertisement stored in the advertisement storage unit 19. Alternatively, there may be another embodiment, as described below.

An advertisement to be newly inserted may be received along with a broadcast independently of the advertisement storage unit 19. Accordingly, when a new advertisement is received along with a broadcast, the advertisement storage unit 19 is not searched, but whether there is another advertisement in the received broadcast is determined. If, as a result of the searching, there is no new advertisement, the advertisement storage unit 19 is searched again. In contrast, if there is a new advertisement, the corresponding advertisement is used without searching the advertisement storage unit 19.

S18; Step of Synthesizing

The advertisement found by the control unit 18 is synthesized with the corresponding broadcast signals. In this case, the editor 17 synthesizes the found advertisement with the broadcast signals decoded through the voice decoding unit 13 and the video decoding unit 14.

As described above, the location at which the advertisement is inserted may vary. In this case, when the location at which the advertisement is to be inserted is the location of an existing advertisement, the source of the advertisement is eliminated and the source of the new advertisement is inserted thereinto.

S20; Step of Outputting Broadcast

Once the insertion and synthesis of the new broadcast is completed, the new broadcast is output via the editor 17 so that a user can view the new broadcast. In this case, when the equipment for receiving digital broadcasts is a digital TV, the output of the digital broadcast is performed via the monitor and speaker of the digital TV. In contrast, when the equipment for receiving digital broadcasts is a digital radio, voice signals are output only via a speaker.

1. An advertisement editing system for digital broadcasting, comprising:
a control unit for, when broadcast packets contained in received digital broadcast signals are decoded in digital broadcasting equipment that receives and outputs broadcast signals, detecting a broadcast and an advertisement contained in the broadcast packets, and searching for a new advertisement that is to replace the advertisement;
an advertisement storage unit for storing one or more new advertisements; and
an editor for editing the decoded broadcast signals and the new advertisement found by the advertisement storage unit, and synthesizing the decoded broadcast signals with the new advertisement so that they can be output via the digital broadcasting equipment;
wherein the advertisement editing system is configured such that it can output content, including the new advertisement, rather than content of the first received digital broadcast signals, while operating in conjunction with the digital broadcasting equipment.

2. The advertisement editing system as set forth in claim 1, wherein a location of the analysis of the new advertisement performed through the editor is one or more selected from the group consisting of a location of the existing advertisement, a vacant space, and a menu bar output onto a monitor.

3. The advertisement editing system as set forth in claim 2, wherein, when the new advertisement is output onto the menu bar, the editor eliminates part or all of the new advertisement output onto the menu bar when a cursor approaches the menu bar to select it.

4. An advertisement editing method for digital broadcasting, comprising:
receiving digital broadcast signals;
analyzing the received digital broadcast signals;
detecting a location at which a new advertisement is to be disposed, in the digital broadcast signals;
searching for the new advertisement to be inserted at the detected location;
inserting the found new advertisement at the location; and
outputting the broadcast signals containing the new advertisement.

5. The advertisement editing method as set forth in claim 4, wherein the digital broadcast signals include a broadcast, including video signals and voice signals, and an advertisement, and the new advertisement replaces the existing advertisement.

6. The advertisement editing method as set forth in claim 4, wherein the digital broadcast signals are output via a digital TV, the broadcast signals are output via part of a monitor of the digital TV, and the new advertisement is output via a remaining part of the monitor.

7. The advertisement editing method as set forth in claim 4, wherein the digital broadcast signals are output via a digital TV, and the location at which the new advertisement is to be inserted is a location of output of a menu bar that is output onto a monitor so that a user can manipulate the digital TV, the new advertisement being eliminated when a cursor, output onto the monitor to manipulate the menu bar, approaches the menu bar.
